(19) United States
(12) Patent Application Publication
(10) Pub. No.: US 2014/0283611 A1
(43) Pub. Date: Sep. 25, 2014

(54) SYSTEM AND A METHOD OF ADAPTIVE FOCUSING IN A PHASED ARRAY ULTRASONIC SYSTEM

(71) Applicants: Jason Habermehl, Quebec (CA); Jinchi Zhang, Quebec (CA)

(72) Inventors: Jason Habermehl, Quebec (CA); Jinchi Zhang, Quebec (CA)

(21) Appl. No.: 13/849,783

(22) Filed: Mar. 25, 2013

(51) Int. Cl. G01B 17/06

(52) U.S. Cl. CPC G01B 17/06
USPC 73/602

(57) ABSTRACT

Disclosed in the present disclosure is a phased array system configured to ultrasonically inspect test targets complex surfaces while employing the surface profiling capability of phased-array linear and sectorial scans. Adaptive focusing is employed for inspecting the test target by using customized apertures according to the surface profiles to generate a plurality of beams that are evenly and thoroughly spaced along a scan line inside the test target.

### FIELD OF THE INVENTION

The present invention relates to non-destructive testing and inspection systems (NDT/NDI) and more particularly to an improvement applied to ultrasonic phased array systems that allows adaptive focusing for inspecting target with complex shaped surfaces.

### BACKGROUND OF THE INVENTION

Test targets with curved, wavy or irregular surfaces have long been a challenge for ultrasonic testing. Different paths have been exploited and explored to resolve problems in this challenge.

One existing effort seen in U.S. Pat. No. 6,424,597 involves using flexible transducers that, to a certain extent, offset the geometric variations to optimize the acoustic coupling and integrate a profile-meter. The profile-meter makes it possible to offset, using delay laws, the aberrations that the ultrasonic beam may undergo when it passes through a complex interface. However, the transducers of this type are put directly in contact with a target piece to be monitored. This leads to the existence of a non-inspectable range of several millimeters (a “dead zone”) under the surface of the piece. To resolve this problem, US 2011/0032800 uses a method to connect a delay line to each element of the flexible transducer. However such solution introduces a detrimental drawback of significantly reducing the transducer's flexibility. These transducers are also not suitable to perform inspection with large incline angles of the refracted beam. These transducers are also typically quite complicated mechanically and can be quite costly, limiting their acceptance by the general market.

Improvements to the flexible transducer concept are being explored in US 2011/0032800, in which a rigid phased-array transducer is used in conjunction with a flexible wedge and a profile-meter to provide focal laws for inspecting a part with complex geometry. However, this solution significantly complicates the inspection and requires additional costly hardware.

Other existing methods have also been explored that do not require complicated profile-meter hardware. Using phased-array ultrasound, it is possible to compensate in many cases for known surface geometries by adjusting the time delays used in transmission and reception. Focal law calculators are commercially available that allow phased-array ultrasonic beams to be designed for simple regular surface geometries. These techniques typically use a prior knowledge of a surface profile to calculate delay law parameters as a function of the position of the probe on the target. These techniques are beneficial in the case of a slightly irregular surface, but their usefulness becomes very limited when the surface is warped due to positioning errors of the transducers and lack of knowledge of the surface's profile.

In U.S. Pat. No. 7,823,454, a method is used in a phased-array probe to ultrasonically define the surface profile of a target. This technique uses a full-matrix-capture technology to process ultrasound data in order to obtain the profile of the surface of the test target and then to inspect the volume of a target by processing the data to compensate for surface irregularities using focal laws corrected for the surface profile. Although the full-matrix capture technology can provide some degrees of advantages over traditional pulse-echo phased array, it presents the disadvantages of requiring substantial data storage and processing requirements.

US patent publications US 2011/0120223 and US 2007/0056373 also exploit similar methods using phased-array ultrasound to determine the surface profile of a test target acoustically and perform inspections with adaptive phased-array focal laws. In these efforts, the entire phased-array probe is used to provide a single sound beam and as such, these attempts do not appear to use the full potential of phased-array system; notably the imaging offered by sectorial and linear scans which are comprised of multiple sound beams can contain volumetric information.

Sectorial and linear scans provide imaging by sonicating a larger region within a test target than a single sound beam can provide and therefore can display the acoustic information obtained from the plurality of sound beams volumetrically.

With linear scans used in PA, the same focal laws are applied for successive active apertures of a phased-array probe. Focal laws are time delays used when pulsing a plurality of elements of a phased array probe in an active aperture to form a sound beam with a predetermined focal position and steering angle (i.e. angle between sound beam and the probe surface). For test targets with simple geometries, refraction at the test target planar surface provides the same consistent refraction angle (i.e. the angle between sound beam and the target's surface) for all sound beams in a linear scan.

However, this standard definition of linear scan cannot be adequately applied to obtain representative volumetric inspections of complex surface targets. As depicted in FIGS. 1a and 1b, a simple geometry is compared to a complex geometry when the same linear scan is applied. In FIG. 1b, the refracted sound beams are not evenly distributed within the target, creating substantial dead-zones in the inspection coverage. Some beams do not even enter into the target due to their high incidence angle on the target complex surface.

With sectorial scans, the active aperture is fixed and focal laws are successively applied to incrementally produce varying steering angles. For a simple surface geometry, this translates into evenly distributed refracted beams at varying refraction angles. However, as with linear scans, it is not possible by using existing sectorial scan techniques to produce evenly distributed refracted beams within test target with complex surface.

### SUMMARY OF THE INVENTION

Accordingly, it is an objective of the present disclosure to provide a method of ultrasonically inspecting test targets having complex surfaces while employing the imaging capability of phased-array linear and sectorial scans.

It is further an object of the present disclosure to define adaptive focal laws for providing linear scan results of the interior of a test target by employing customized apertures to generate a plurality of beams that are evenly spaced along a scan line and have the same refraction angle inside the test target.

It is further an object of the present disclosure to define adaptive focal laws for providing sectorial type scan results of the interior of a test object by employing customized apertures to generate a plurality of beams that all pass through a common point and are angularly evenly spaced with respect to refraction angle inside the test target.

Another objective of the present disclosure is to provide for the use of a typical phased-array probe to perform adaptive focusing in order to inspect targets with complex surfaces.

Yet another objective of the present invention is to provide methods for measuring the surface profile of a complex target such as a weld cap using phased array ultrasonic testing.

The invention disclosed herein aims to resolve the aforementioned drawbacks related to the known arts for ultrasonically inspecting a target with a wavy or uneven surface. A typical phased-array probe is operated with a substantial fluid layer such as water between the array transducer and the test target surface. The fluid layer is maintained by immersing the target in liquid or by using a captive couplant column between the probe and the target surface. The surface profile of the target is measured acoustically for a given probe position. Adaptive phased-array focal laws for both sectorial and linear scans are defined and re-emitted based on improved electronic scan concepts and the measured surface profile.

### BRIEF DESCRIPTION OF THE DRAWINGS

FIGS. 1a and 1b present schematic diagrams showing prior art of a linear scan applied respectively on simple and complex surface test targets.

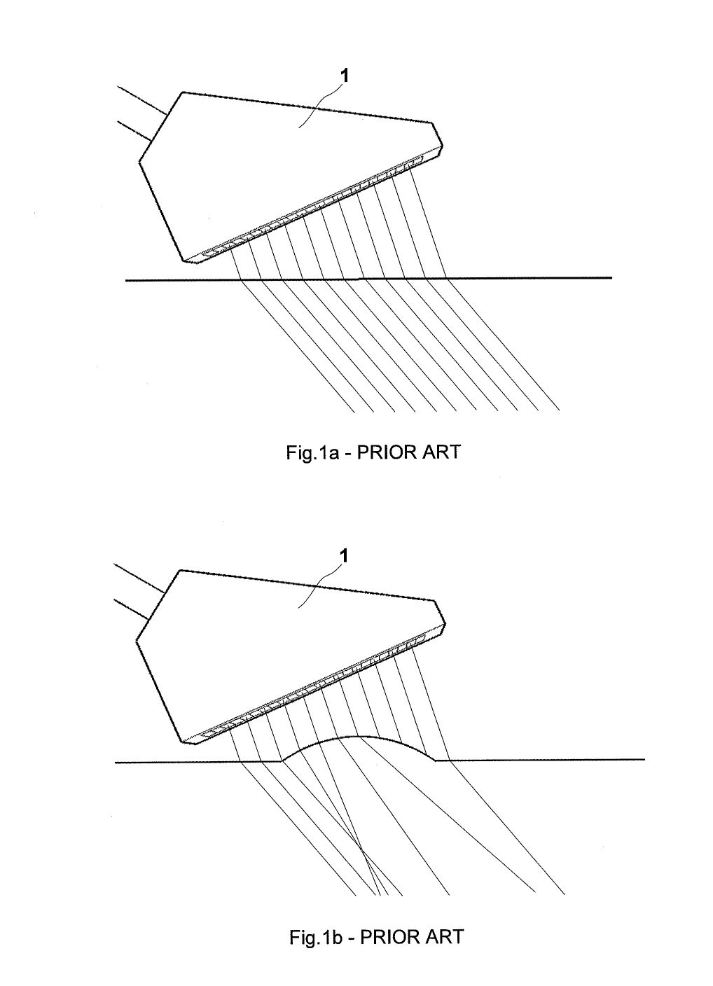

FIG. 2 is a schematic diagram showing the presently disclosed phased-array adaptive focusing system.

FIG. 2a is a schematic diagram showing an alternative embodiment of the presently disclosed phased-array adaptive focusing system.

FIGS. 3a, 3b, 3f form a group of schematic diagrams showing an example of a multi-group focal laws arrangement used for surface profiling.

FIG. 4 is a schematic diagram showing an example of ray-tracing used to determine the center-of-aperture on a phased-array transducer for the case of a sectorial angle beam scan using true depth focusing.

FIG. 5 is a schematic diagram showing an example of ray-tracing used to determine the center-of-aperture on a phased-array transducer for the case of an angle beam linear scan using true depth focusing.

FIG. 6 is a functional block diagram showing the procedure of PA inspections with adaptive focusing deployed according to presently disclosed method.

### DETAILED DESCRIPTION OF THE INVENTION

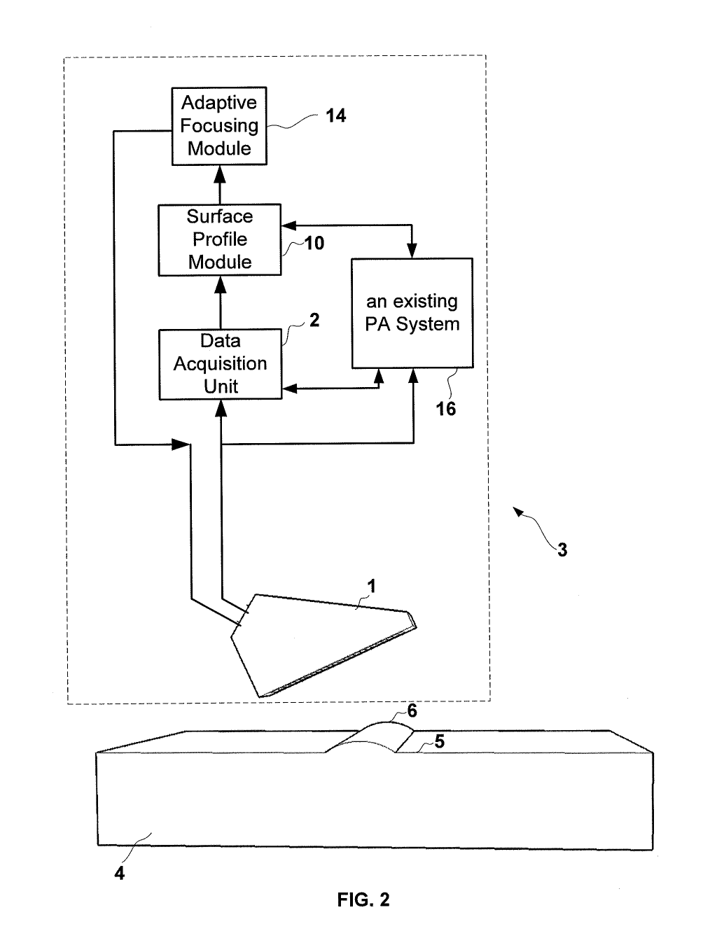

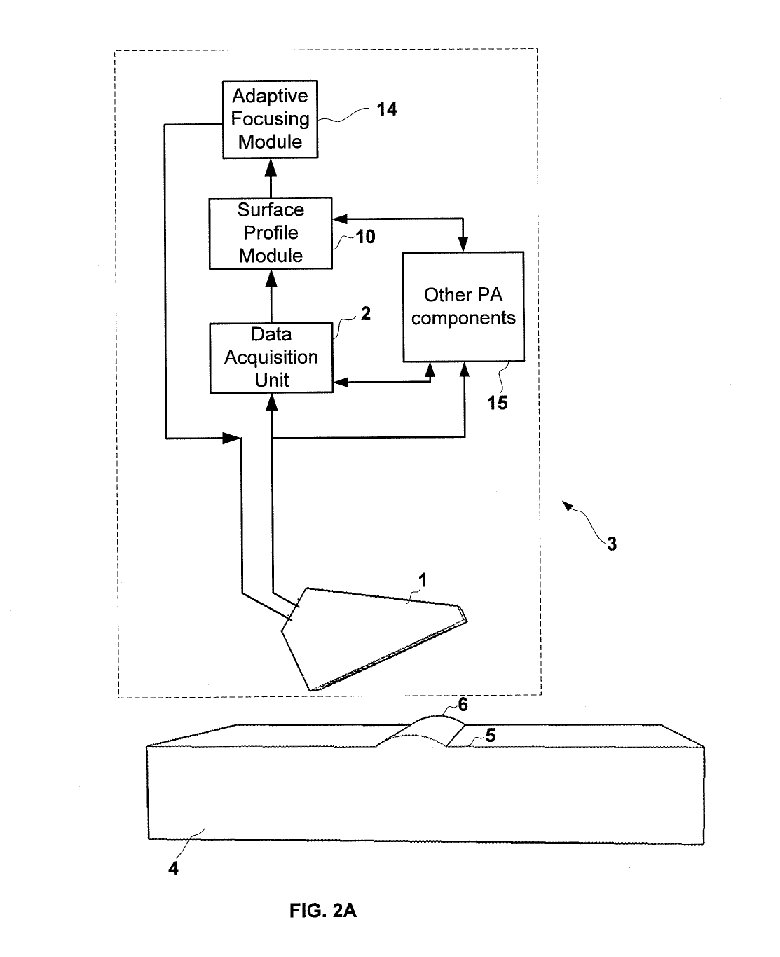

Referring to FIG. 2, an adaptive phased-array inspection system 3 according to a preferred embodiment of the present invention is comprised of a phased-array (PA) probe 1, an acquisition unit 2 and a data processing and display unit 16. Data processing and display unit 16 can be an existing PA system. A test object or target 4 featuring a complex inspection surface 5 that takes the form of weld cap 6 is herein used as an exemplary test target since it closely pertains to the problem that the present disclosure deals with. Albeit the complex nature of surface 5, ultrasound beams are required to pass through the surface in order to inspect within the volume of the target 4. It should be noted that PA probe 1 can interchangeably be one of a plurality of phased array probes compatible with system 3. Probe 1 is coupled to test target 4 via a layer of substantial amount of fluid by either immersing the target and transducer or by using a captive water column between the transducer and target surface (not shown).

Adaptive phased-array inspection system 3 (later as “adaptive system 3”) further embodies a surface profile module 10 and an adaptive focusing module 14. Surface profile module 10 receives information from data acquisition unit 2, produces a surface profile pertaining to the complex surface 5. Adaptive focusing module 14 then employs an adaptive focusing process, instructing processing and display unit 16 to perform adaptive focusing.

It should be appreciated that acquisition unit 2 and processing and display unit 3 can alternatively be assembled integrally in a more portable version of PA system 3, the embodiment of which is within the scope of the present disclosure.

It can be understood that the adaptive system shown in FIG. 2 comprises novel components of profile module 10 and adaptive focusing module 14, which can be added onto an existing PA system 3 (processing and display unit). Alternatively as shown in FIG. 2A, novel components of profile module 10 and adaptive focusing module 14 can be deployed directly within an integral part of a new PA system 3, together with conventional existing phased-array components, collectively as 15. It should be appreciated that the configurations shown in both FIG. 2 and FIG. 2A, namely using the novel components as add-on portions to an existing PA system, or employing such novel components as an integral part of a newly designed PA system, are within the scope of the present disclosure.

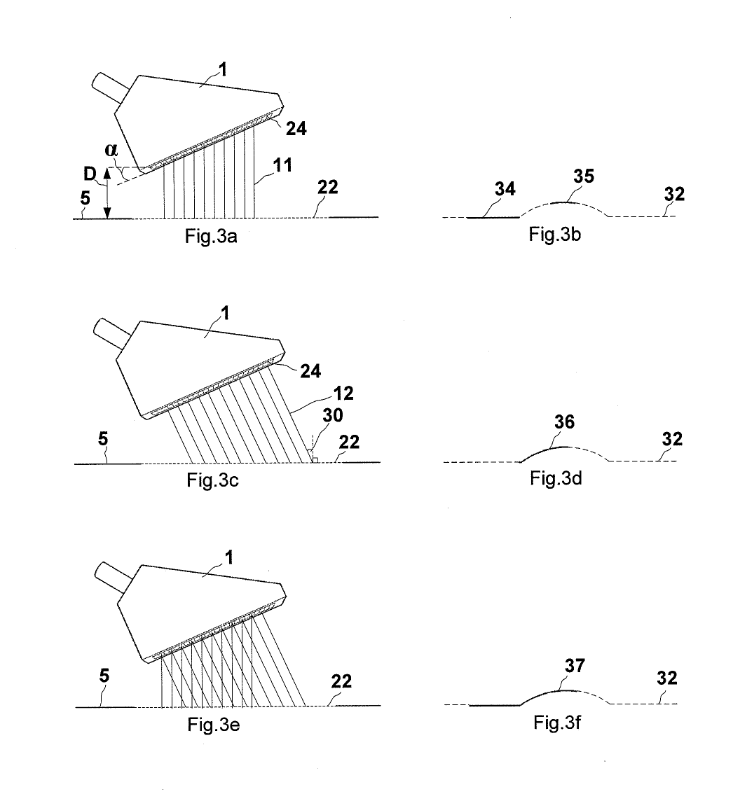

Reference is now made to FIGS. 3a, 3b, 3f which exhibit more details on how a surface profile is provided with surface profile module 10. The surface profile of target 4 is measured acoustically by first acquiring multiple phased-array linear scans using PA probe 1. This represents one of the novel aspects of the present invention, since conventionally phased operations directly engage into inspection, assuming the surface of the test object to be flat. As shown in FIG. 3a, PA transducer 1 is not substantially parallel to the nominal target surface reference 22. According to the preferred embodiment of the invention, distance D and angle α between probe 1 and the surface 5 are known except for the region in the vicinity of the weld cap 6 (in FIG. 2). The surface profile of target 4 can be determined acoustically by profile module 10 according to data acquired by acquisition unit 2 from multiple phased-array linear scans with at least two steering angles (i.e. angle between PA probe active surface 24 and acoustic beams). As depicted in FIG. 3a, a first linear scan 11 is performed with the acoustic beams directed substantially perpendicular to the expected nominal target surface orientation. Additionally, as depicted in FIG. 3c, a second linear scan 12 is performed without a steering angle such that the acoustic beams are basically perpendicular to the PA probe active surface 24. Advantageously, the plurality of beam angles employed for surface profiling provides more appropriate surface profiling of complex geometries.

The acoustic information obtained by this plurality of linear scans as shown in FIGS. 3a-3f can be processed to profile the entire surface of the target through which inspection beams traverse. For example as shown on FIG. 3b, linear scan 11 provides bases for profiling about surface profile sections marked as 34 and 35, as the acoustic beams are more or less perpendicular to these surface sections. Linear scan 12 provides profiling of surface section 36 of FIG. 3d for the same reasons. As shown in FIGS. 3e and 3f, combing the profiling information from this plurality of linear scans allows for profiling the entire relevant surface profile 37. Dashed line 32 shows the actual surface profile in this example.

With the knowledge of the target complex surface distribution with respect to probe 1 provided by the surface profiling method described above, adaptive focal laws can be further performed by the adaptive focusing module as described below.

Focal laws for simple geometries are typically defined by a user selected parameters such as focal depth and beam refraction angle for linear scans or angles for sectorial scans. Beam spacing is also used to define the overall scan resolution. This approach in the conventional practice is adopted herein. In this embodiment, focal depth, beam refraction angle and beam spacing constitute the principle beam parameters. These beam parameters are defined with respect to the nominal target surface reference 22 shown in FIGS. 3a-3f.

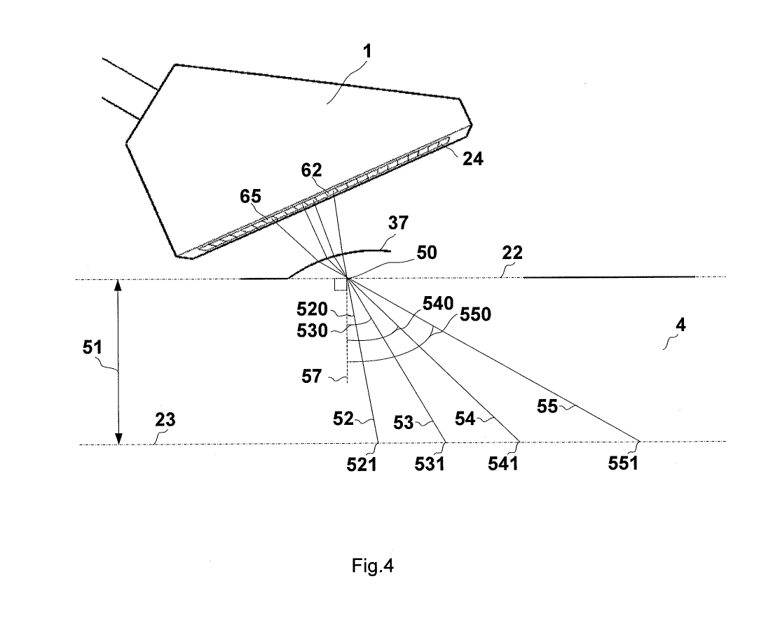

Reference is now primarily made to FIG. 4, with continued reference to previous figures to describe the principle and scope of adaptive focusing devised by the present disclosure. In an exemplary case adaptive focusing is applied by module 14 with focal law definition for sectorial scans corresponding to measured surface profile 37. In an adaptive sectorial scan according to the exemplary embodiment, beam intersection point 50 is situated vertically on target surface reference 22 and is defined horizontally by the user or by some other means. For instance, in the case of weld bevel inspection, intersection point 50 could be chosen as to ensure complete coverage of the bevel line. It could also be defined simply by extending a perpendicular line from plane 22 to the middle of the phased-array. It should be noted that this represents one of the novel aspects of the present invention as conventional phased-array sectorial scans are characterized by a beam intersection point on the probe active surface 24. From beam intersection point 50, a plurality of beams 52, 53, 54 and 55 can be extended according to beam parameters such as refraction angle and beam angular spacing. Beam refraction angles are defined based on plane 57 which is perpendicular to target surface reference 22 in such a fashion that beam 52 is defined by refraction angle 520, beam 53 is defined by refraction angle 530 and so on. Beam spacing for sectorial scans is defined as the angular gap between successive beams. The last critical beam parameter is focal depth referred as 23 in FIG. 4, which is defined as a plane parallel to target surface reference 22 offset vertically by distance 51. Focal points 521, 531, 541, and 551 are defined at the intersection of beams 52, 53, 54 and 55, respectively, and focal depth 23.

Continuing with FIG. 4, the geometrical extension of beams 52, 53, 54 and 55 from their respective focal points through beam intersection point 50 towards probe active surface 24 is used to define the aperture position along the phased array that is the most appropriate for a given beam. Upon intersecting measured surface profile 37, commonly known Snell's law is used to calculate the beam incident angle prior to refraction according to refraction angles 520, 530, 540 and 550 and the known sound velocities of target 4 and the fluid coupling layer. For example, the extension of beam 52 intersects with probe element 62 on probe active surface 24 whereas the extension of beam 55 intersects with probe element 65 on probe active surface 24. Elements 62 and 65 are then defined as the center of aperture for generating phased-array beams 52 and 55 focusing at focal points 521 and 551, respectively. Once an optimal center of aperture is selected according to the above method for a given focal point, conventional phased-array focal law calculation methods can be deployed to calculate pulsing delays for all of the phased-array probe elements that constitute a given aperture, contributing to a given focal law. In this regards, a focal law is a precise combination of element delays in a given aperture for focusing at a precise focal point according to the respective surface profile.

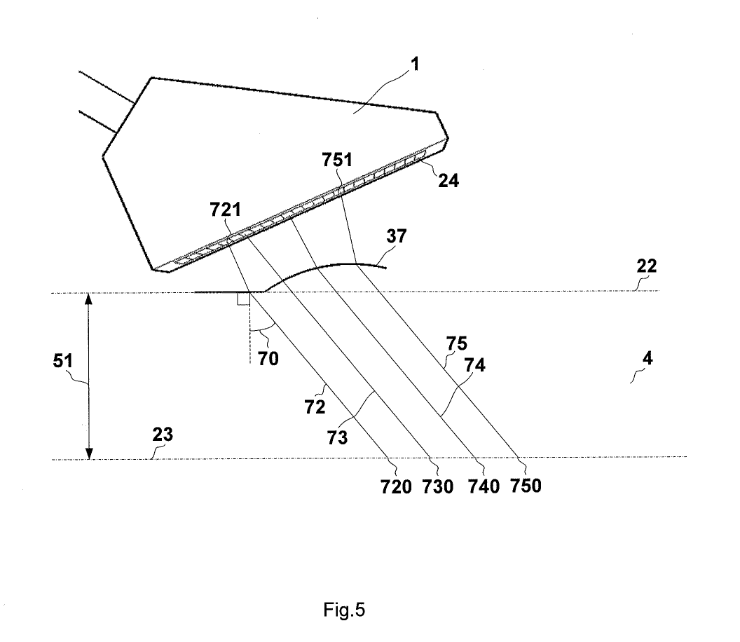

Reference now is made primarily to FIG. 5, with continued reference made to previous figures. FIG. 5 illustrates a process which can be devised in an alternative embodiment of focusing module 14, using linear scans to achieve the adaptive focusing corresponding to surface profile 37. Similar to the previous example shown in FIG. 4, PA probe 1 is not substantially parallel to nominal target surface reference 22 and the distance D and angle α between probe 1 and the surface 5 are known except for the region in the vicinity of the weld cap 6.

After beam parameters are defined by the user, a plurality of focal points 720, 730, 740 and 750 can be defined. In this embodiment, all focal points are defined on the horizontal plane associated with focal depth 23 at a distance 51 below the target surface reference 22. From each of these focal points, a beam is traced starting from the focal points towards the nominal target surface reference 22 with an orientation parallel to refraction angle 70 defined related to a plane perpendicular to target surface reference 22. For example, from focal point 720, beam 72 is traced with angle 70 towards reference plane 22.

Continuing with FIG. 5, with the surface profile found by module 10, the geometrical extensions of beams 72, 73, 74 and 75 from their respective focal points along an orientation parallel to refraction angle 70 towards probe active surface 24 are used to define the respective phased-array probe aperture that is the most appropriate for a given beam. Upon intersecting measured surface profile 37, commonly known Snell's law is used to calculate the beam incident angle prior to refraction according to refraction angle 70 and the known sound velocities of target 4 and the fluid coupling layer. For example, the extension of beam 72 intersects with probe element 721 on probe active surface 24 whereas the extension of beam 75 intersects with probe element 751 on probe active surface 24. Elements 721 and 751 are subsequently defined as the center of aperture for generating phased-array beams 72 and 75 focusing at focal points 720 and 750 respectively. Similarly, once an optimal aperture center for all the intended focusing points has been selected, conventional phased-array focal law calculation methods can be deployed to calculate pulsing delays for all of the phased-array probe elements in a given aperture, contributing to a given focal law. In this regards, a focal law is a precise combination of element delays in a given aperture for focusing a precise focal point according to the respective surface profile.

It should be noted that the linear scan or sectorial scan can be also herein referred to as an electronic scan.

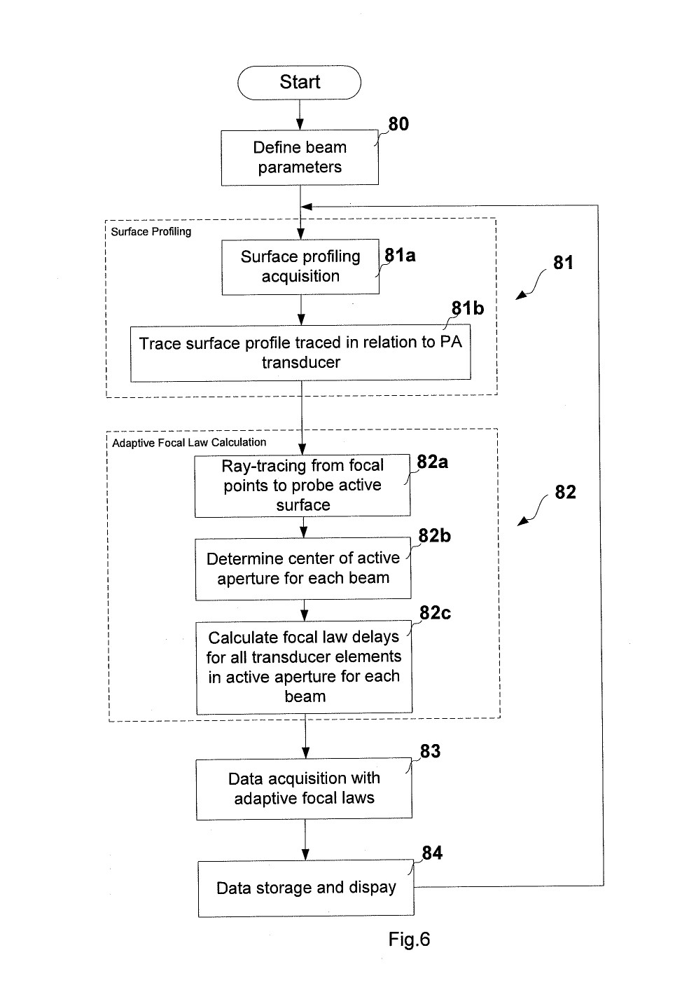

Referring primarily now to FIG. 6 and continuingly to previous figures, the surface profiling and adaptive focusing methods as aforementioned are described in a flowchart diagram. In a first step 80, the beam parameters are defined, adopting conventional practice. These would typically be defined by the user. These parameters include but are not necessarily limited to: material acoustic velocity, delay-line parameters, inspection scan type (linear or sectorial), refraction angle or angles, focusing type and distance and aperture size, beam spacing. Delay-line parameters can include delay-line acoustic velocity, height and nominal angle between transducer active surface and target surface (if known).

In step 81, the surface profile of the target is obtained by executing surface profile module 10, which executes a sequence of two sub-steps, 81a and 81b. In step 81a, multiple runs of phased-array acquisition are performed according to the method described in group FIGS. 3. Step 81a includes multiple runs of phased-array acquisitions used for acquiring acoustic data for the intent of surface profiling and would typically include two or more combinations of sectorial and/or linear scans at different steering angles. In step 81b, the profile module calculates the complex surface profile distribution according to the data acquired in 81a.

With the surface profile determined in the abovementioned step 81, adaptive focal laws are calculated for a given scan position in step 82, which is executed by adaptive focusing module 14. Step 82 comprises sub-step 82a in which an ultrasonic ray is traced from the focal point to the probe active surface by applying Snell's law at the target surface interface. In the case of a sectorial scan, all rays would intersect at a pre-determined position 50 shown in FIG. 4. Sub-step 82b comprises defining the center-of-aperture of the beams as the position on the phased-array transducer active surface where the ray impinges and sub-step 82c comprises calculating focal law delays for an aperture of a given number of elements centered at the center-of-aperture. Steps 82a, 82b and 82c are repeated for all beams in the scan. Method and process associated with FIGS. 4 and 5 should be employed in implementing details of step 82.

In step 83, the same phased-array transducer is used to acquire acoustic data for all beams in a scan by using the adaptive focal laws calculated in step 82 relative to the surface profile determined in step 81. In step 84, the acquired acoustic data is stored and typically displayed to the user.

After all of the focal laws are acquired for all beams in a scan for a given probe position, a typical scan would include moving or incrementing the probe to a different position on the target part and the above mentioned steps from 81 to 83 are repeated in order to profile the target surface, calculate new adaptive focal laws and acquire acoustic data with the adaptive focal laws .

It should be noted that the steps 81, 82, 83 and 84 could form a complete scan at one inspection location. For an example of weld inspection, at one specific weld axial location, the system can be operated to execute steps 81, 82, 83 and 84 to achieve one scan sequence for inspection of the corresponding weld axial location. When the probe is moved onto the subsequent axial location, another round of steps 81, 82, 83 and 84 can be repeated.

However, the present disclosure is not restricted to such scanning routine. Alternatively, especially when the weld surface is not expected to change dramatically, the rate of the execution of routine 81 might be chosen to be slower than the rate of scan. In another words, the surface profile does not have to be updated for each scan sequence. It can be alternatively defined by the user to be updated, for example, once every two or five, or 10 scans sequence, depending on the uniformity and consistency of the weld are perceived to be.

Although the present invention has been described in relation to particular exemplary embodiments thereof, many other variations and modifications and other uses will become apparent to those skilled in the art. It is preferred, therefore, that the present invention not be limited by the specific disclosure.

Although the above descriptions have been shown to apply to a phased-array transducer not substantially parallel to nominal target surface reference 22, it must be recognized that the scope of this invention is intended to cover alternative relative positions of phased-array transducers and target surface as well as alternative refraction angles. Notably, the phased-array transducer could be positioned substantially parallel to the nominal target surface reference. This invention would also apply to using phased-array transducers that are not substantially flat.

Furthermore, although the preferred embodiment described two or more linear scans to be used for surface profiling, it must be recognized that any combination of electropnic scans can be used to this effect.

It must also be recognized that although true depth focusing is described herein, this invention is not specific with respect to the focusing type. As such, focusing alternatives such half-path and custom plane projections are within the scope of this invention.

It should also be recognized that the electronic scan beam definitions described herein would apply to other similar phased-array acquisition methods such as full-matrix capture.

Although an immersion type delay-line is described herein, it must be recognized that alternative adaptable coupling methods such as soft conformable polymeric materials are compatible with the teachings herein, which would not affect the scope of the present invention.

What is claim is:

1. A phased array ultrasonic inspection system configured to inspect a test object having
a complex test surface, the system comprising:
a phased array probe configured to emit and receive ultrasonic signals from the test object,
an ultrasonic signal acquisition unit receiving electronic echo signal data;
a surface profile module configured to conduct at least one profiling routine to facilitate a set of profiling focal laws, analyze the corresponding echo signal data and define the geometric profile of the test surface;
a programmable logical processor further comprising an adaptive focusing module configured to conduct at least one adaptive focusing routine to define at least one adaptively focused electronic scan which is partially defined by at least one center of at least one aperture of the probe according to the geometric profile,
wherein the logical processor facilitates to inspect the test object by applying the defined electronic scan.

2. The system of claim 1, wherein each of the at least one electronic scan is performed by emitting and receiving one time of a plurality of ultrasonic beams via the at least one aperture of the probe.

3. The system of claim 1, wherein the inspection system inspects the test object at N test locations with N times of the at least one electronic scan, executing M times of the surface profile routine and P times of the adaptive focusing routines.

4. The system of claim 3, wherein M is less or equal to N; P is less or equal to N.

5. The system of claim 1, wherein the profile module conducts the profiling routine with J number profiling focal laws corresponding to J number of parts of the test surface.

6. The system of claim 1 wherein the profiling focal laws are either linear or sectorial scans.

7. The system of claim 2, wherein the electronic scan is of sectorial scan.

8. The system of claim 7, wherein the beams of the sectorial scan are configured to enter into the test object forming angles with an imaginary vertical plane, the angles are such defined that the beams travel into the test object to completely and uniformly cover the test object to be inspected, the vertical plane is perpendicular to a reference surface and crosses an intersection point on the reference surface, the intersection point is user defined according to the inspection specifications, the beams are extended towards the probe active surface, intersecting the test surface with the profile as defined, reaching an element of the probe along an incident angle according to Snell's law, wherein the element is defined as the at least one center of the aperture.

9. The system of claim 2, wherein the electronic scan is of linear scan.

10. The system of claim 9, wherein the beams of the linear scan are configured to enter into the test object reaching a desired inspection depth with plurality of inspection points to completely and uniformly cover the test object to be inspected, the beams are traced as originated from their respective inspection points along an orientation parallel to a refraction angle towards the probe active surface, intersecting the test surface with the profile as defined, tracing back to an element of the probe along an incident angle according to Snell's law, wherein the element is defined as the center of the aperture.

11. An adaptive focusing unit configured to work with a phased array ultrasonic inspection system to inspect a test object having a complex test surface, the inspection system is coupled with a phased array probe and an ultrasonic signal acquisition unit,
the adaptive focusing unit comprising:
a surface profile module configured to conduct at least one profiling routine to facilitate a set of profiling focal laws, analyze the corresponding echo signal data and define the geometric profile of the test surface;
an adaptive focusing module configured to conduct at least one adaptive focusing routine to define at least one adaptively focused electronic scan which is partially defined by at least one center of at least one aperture of the probe according to the geometric profile,
wherein the inspection system has a logical processor facilitating the inspection of the test object by applying the defined electronic scan.

12. The adaptive focusing unit of claim 11, wherein each of the at least one electronic scan is performed by emitting and receiving one time of a plurality of ultrasonic beams via the at least one aperture of the probe.

13. The adaptive focusing unit of claim 11, wherein the profiling focal laws are either linear or sectorial scans.

14. The system of claim 12, wherein the electronic scan is of sectorial scan.

15. The system of claim 14, wherein the beams of the sectorial scan are configured to enter into the test object forming angles with an imaginary vertical plane, the angles are so defined that the beams travel into the test object to completely and uniformly cover the test object to be inspected, the vertical plane is perpendicular to a reference surface and crosses an intersection point on the reference surface, the intersection point is user defined according to the inspection specifications, the beams are extended towards the probe active surface, intersecting the test surface with the profile as defined, reaching an element of the probe along an incident angle according to Snell's law, wherein the element is defined as the at least one center of the aperture.

16. The system of claim 12, wherein the electronic scan is of linear scan.

17. The system of claim 16, wherein the beams of the linear scan are configured to enter into the test object reaching a desired inspection depth with plurality of inspection points to completely and uniformly cover the test object to be inspected, the beams are traced as originated from their respective inspection points along an orientation parallel to a refraction angle towards the probe active surface, intersecting the test surface with the profile as defined, tracing back to an element of the probe along an incident angle according to Snell's law, wherein the element is defined as the center of the aperture.

18. A method of adaptive focusing for a phased array ultrasonic inspection system configured to inspect a test object having a complex test surface, the system is coupled with a phased array probe, the method comprising steps of:
a) applying a set of profiling ultrasonic scans;
b) analyzing echo signal data corresponding to the profiling scan;
c) defining the geometric profile of the test surface as a defined profile;
d) defining a sequence of adaptively focused electronic scans by defining at least one center of at least one aperture of the probe according to the defined profile,
e) applying an electronic scan to inspect the test object employing the defined center of the at least one aperture according to the defined profile.

19. The method of claim 18, wherein the profiling scans are either linear or sectorial scans and are conducted by electronic beams, each of which corresponds to a specific of the at least one aperture.

20. The method of claim 18, wherein the electronic scan is a sectorial scan.

21. The method of claim 20, wherein the beams of the sectorial scan are configured to enter into the test object forming angles with an imaginary vertical plane, the angles are so defined that the beams travel into the test object to completely and uniformly cover the test object to be inspected, the vertical plane is perpendicular to a reference surface and crosses an intersection point on the reference surface, the intersection point is user defined according to the inspection specifications, the beams are extended towards the probe active surface, intersecting the test surface with the profile as defined, reaching an element of the probe along an incident angle according to Snell's law, wherein the element is defined as the at least one center of the aperture.

22. The system of claim 18, wherein the electronic scan is a linear scan.

23. The system of claim 22, wherein the beams of the linear scan are configured to enter into the test object reaching a desired inspection depth with plurality of inspection points to completely and uniformly cover the test object to be inspected, the beams are traced as originated from their respective inspection points along an orientation parallel to a refraction angle towards the probe active surface, intersecting the test surface with the profile as defined, tracing back an to an element of the probe along an incident angle according to Snell's law, wherein the element is defined as the center of the aperture.
